(19) United States
(12) Patent Application Publication
(10) Pub. No.: US 2005/0182746 A1
(43) Pub. Date: Aug. 18, 2005

(54) Integrated database management of protein and ligand structures

(76) Inventors: Steven J. Potts, San Diego, CA (US); Sandor Szalma, San Diego, CA (US); Yin Yu, San Diego, CA (US); Scott D. Kahn, Poway, CA (US); David Edwards, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/997,687

(22) Filed: Nov. 24, 2004

Related U.S. Application Data
(60) Provisional application No. 60/525,280, filed on Nov. 26, 2003.

(51) Int. Cl. G06F 7/00

(52) U.S. Cl. 707/1

(57) ABSTRACT

Systems and methods for storing protein structure information are provided. The system comprises a non-public database storing protein structure information, wherein the non-public database is coupled to a public database of non-proprietary protein structure information and to non-public sources of proprietary protein structure information. The non-public database may also be coupled to a database having protein structure information for substantially all the proteins of at least one organism genome. The method may comprise loading protein structure data from at least one public database and loading protein structure data from one or more proprietary sources of protein structure information. The public database may comprise the Protein Data Bank (PDB). Certain types of additional information are also advantageously loaded into the database. These may include classification data corresponding to at least one protein ontology. Mass spectroscopy data, NMR data and x-ray crystallography data may also be loaded into the database.

### CROSS REFERENCE TO RELATED APPLICATIONS

This application claims priority under §119 to U.S. Provisional Application No. 60/525,280 filed Nov. 26, 2003 which is incorporated herein by reference in its entirety.

### BACKGROUND OF THE INVENTION

Commercial drug discovery depends on integrated structural efforts across a diverse set of groups spanning target discovery, target validation and characterization, and ligand design. An x-ray crystallographer may be solving an important target structure, understanding the significance of known sequence mutations, or analyzing data on bound ligands to identify the determinants of ligand binding behavior in a protein active site. A medicinal chemist whose core expertise is in wet chemistry also has need to access the same x-ray data—typically electron density maps centered on the ligand of interest—in a straightforward manner that does not require more than a couple of mouse clicks to access a summary of the detailed structural conclusions of the data. Spanning the purview of both of these scientists is a computational chemist that requires the ability to retrieve, analyze, and save one of thousands of in silico docked structures to effectively extend the understanding of the protein target beyond the scope of existing experimental data. All of these activities occur as the bioinformaticians responsible for managing target information move from purely sequence-based to more structurally-driven research that requires the ability to query homology (structural) models, conserved active sites, ligand binding pockets, and structural motifs across and between entire genomes. Supporting this evolution towards deeper understanding of the protein target, a high-throughput mass spectroscopy laboratory may need to search a structurally annotated genome for hits against isolated proteins in a diseased sample. As a team all of these researchers have the need to access available public structural data (protein, ligand, and/or x-ray data) alongside proprietary data in a secure approach that does not compromise an organization's intellectual property (IP). Often research project teams are geographically separated but need to be able to work with the same data in a fashion that provides data versioning, ownership, and curation.

The RCSB Protein Data Bank (PDB) has proven to be a valuable resource of public protein data for structural biologists worldwide. Effort is currently underway to improve the curation of the PDB via “clean” mmCIF files and expanded search capabilities. However, the need to access public protein structures in a secure fashion and the seamless interaction with both proprietary and public structures has not been addressed. The Relibase commercial product has been offered as a richer, in-house version of the Protein Data Bank; albeit, Relibase is a read-only system that does not allow researchers to deposit their own structures. Relibase does not offer any x-ray functionality which significantly limits its ability to capture all necessary information of a protein structure that has been determined experimentally.

Functional genomics approaches to the protein data management challenges are typified by the Biopendium product from Inpharmatica which offers annotated genomes but no homology (structural) models. Biopendium is also a closed system with no provision for the registration or storage of the proprietary target information developed by a research team. In contrast, while enterprise genomic and proteomic sequence data management systems such as the SeqStore product support the registration of proprietary sequence data, the domain is strictly limited to sequence data and there is no provision for the handling of structural information in any capacity.

The following references describe several features of protein databases, and are incorporated by reference in their entireties.
1. Bernstein, F. C., Koetzle, T. F., Williams, G. J. B., Meyer, E. F., Brice, M. D., Rodgers, J. R., Kennard, O., Shimanouchi, T., and Tasumi, M. (1977) The Protein Data Bank: a computer-based archival file for macromolecular structures. J. Mol. Biol., 112, 535-542.
2. Berman, H. M., Westbrook, J., Feng, Z., Gilliland, G., Bhat, T. N., Weissig, H., Shindyalov, I. N., and Bourne, P. E. (2000) The Protein Data Bank. Nucleic Acids Res., 28, 235-242.
3. Westbrook, J., Feng, Z., Jain, S., Bhat, T. N., Thanki, N., Ravichandran, V., Gilliland, G. L., Bluhm, W., Weissig, H., Greer, D. S., Boume, P. E., and Berman, H. M. (2002) The Protein Data Bank: unifying the archive. Nucleic Acids Res., 30, 245-248.
4. Boutselakis, H., Dimitropoulos, D., Fillon, J., Golovin, A., Henrick, K., Hussain, A., Ionides, J., John, M., Keller, P. A., Krissinel, E., McNeil, P., Naim, A., Newman, R., Oldfield, T., Pineda, J., Rachedi, A., Copeland, J., Sitnov, A., Sobhany, S., Suarez-Uruena, A., Swaminathan, J., Tagari, M., Tate, J., Tromm, S., Velankar, S., and Vranken, W. (2003) E-MSD: the European Bioinformatics Institute Macromolecular Structure Database. Nucleic Acids Res., 31,458-462.
5. Altschul, S. F., Madden, T. L., Schaffer, A. A., Zhang, J. H., Zhang, Z., Miller, W. and Lipman, D. J. (1997) Gapped BLAST and PSI-BLAST: a new generation of protein database search programs. Nucleic Acids Res., 25, 3389-3402.
6. Murzin, A., Brenner, S. E., Hubbard, T. J. P. and Chothia, C. (1995) SCOP: a Structural Classification of Proteins database for the investigation of sequences and structures. J. Mol. Biol., 247, 536-540.
7. Dowell, R. D., Jokerst, R. M., Day, A., Eddy, S. R., and Stein, L. (2001) The Distributed Annotation System. BMC Bioinformatics, 2,7.
8. Hahn, M. A., J. Med. Chem., 38, 2080-2090, 1995; Hahn, M. A. J. Chem. Inf. Comput. Sci., 37, 80-86, 1997.
9. Sudarsanam, S.; Virca, G. D.; March, C. J.; Srinivasan, S. J. Computer-Aided Mol. Des., 1992, 6, 223-233.

### SUMMARY OF THE INVENTION

In one embodiment, a system for storing protein structure information is provided. The system comprises a non-public database storing protein structure information, wherein the non-public database is coupled to a public database of non-proprietary protein structure information and to non-public sources of proprietary protein structure information. The non-public database may also be coupled to a database having protein structure information for substantially all the proteins of at least one organism genome.

In another embodiment, a method of creating database records related to protein structure is provided. The method may comprise loading protein structure data from at least one public database and loading protein structure data from one or more proprietary sources of protein structure information. The public database may comprise the Protein Data Bank (PDB). Certain types of additional information are also advantageously loaded into the database. These may include classification data corresponding to at least one protein ontology. In some embodiments, protein mappings to ontology nodes are stored in relational table format, and relationships between ontology nodes are stored in a different format such as XML for example. Mass spectroscopy data, NMR data and x-ray crystallography data may also be loaded into the database.

### BRIEF DESCRIPTION OF THE DRAWINGS

FIG. 1 is a block diagram of a protein structure database in accordance with one invention embodiment.

FIG. 2 is a block diagram of database information associated with a stored structure.

### DETAILED DESCRIPTION

Currently available structural databases tend to either be ligand- or protein-centric, and are typically oriented to meet the more narrow needs of only one of the above described user groups. Further, consideration of protein structural information from an IP perspective is lacking vis-á-vis data registration and access security.

The inventions described herein have been developed to address the unmet needs of modern day drug discovery teams to securely capture structural protein target information in conjunction with ligand information available from crystallographic, spectroscopic, and in silico experiments. As such these inventions relate to an enterprise relational database that integrates molecular and macromolecular structure, x-ray crystallographic and NMR spectroscopic data on macromolecular structures and ligand complexes, and proteomic mass spectroscopy database searching within a unified system for registration, storage, and retrieval. Data sources include regular parsing of the public data in the Protein Data Bank, as well as links to ancillary descriptive information on protein structure-function contained e.g. within SCOP, GO, and E.C. Additionally entire genomes from public and/or proprietary sources can be managed along with rich structural annotations derived using in silico techniques such as those embodied within the DS GeneAtlas pipeline. Protein structural data can be stored along with any available experimental x-ray crystallographic or NMR spectroscopic data for isolated protein structures and protein structure with bound ligands. All data is time stamped and versioned, stored securely in an Oracle relational database.

The inventive database extends beyond a traditional data warehouse in that the data management system that facilitates users to deposit, register, edit, and delete structural data to support the capture of IP of specific protein targets. Here registration is meant to encapsulate the automatic enrichment of the raw structural information using in silico techniques and/or the linking of available structure-function information and/or the application of standard business rules during the loading process. The design of a workable system requires care in the definition of database scope—which data sources will and will not be included—and especially how the data will be updated and versioned.

The unifying focus of the database is structural protein data, both experimental and computationally derived. It has also been found advantageous to include ligand structures that are bound to proteins, but minimize or eliminate the presence of ligand only information where the ligand is not associated with a protein complex in the database. The database includes protein sequences that contain structural annotation—homology models, active sites, binding pockets, structural motifs, crystallographic and/or spectroscopic data, and is an improvement over protein sequence databases without structural annotation, e.g., as embodied within SwissProt or GenBank, or sequence-only database (e.g., SRS or SeqStore).

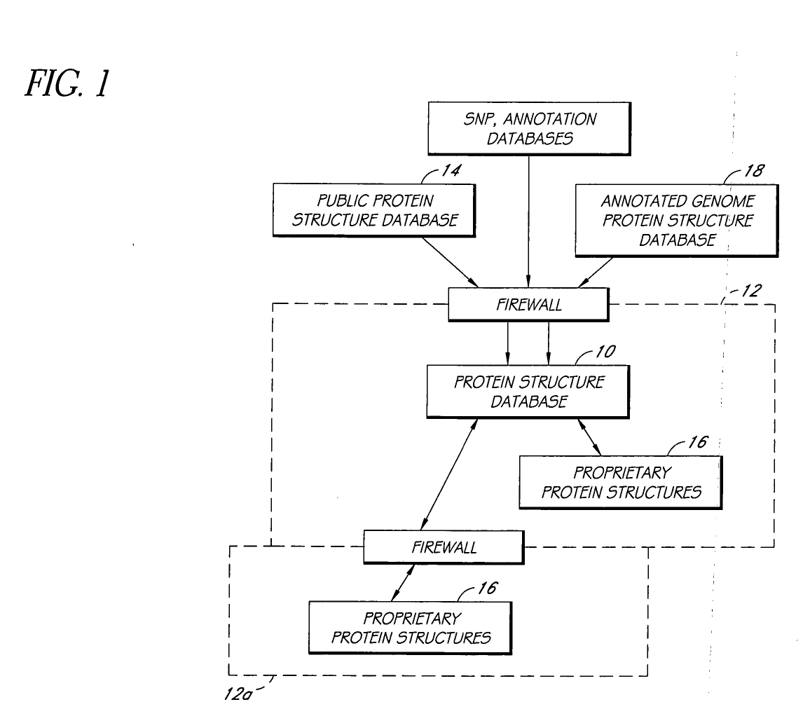

FIG. 1 illustrates a block diagram illustrating the protein structure database 10 and several of the data sources that can be used to populate it. The database is typically non-public, and is controlled and maintained in most cases in a commercial drug discovery entity 12 that wishes to integrate and utilize both publicly available protein data as well as its own internally developed and proprietary protein data. The entity 12 may be geographically dispersed, as illustrated by separate box 12a on FIG. 1, but it is advantageous to the entity 12 that unauthorized access to the database 10 be prevented.

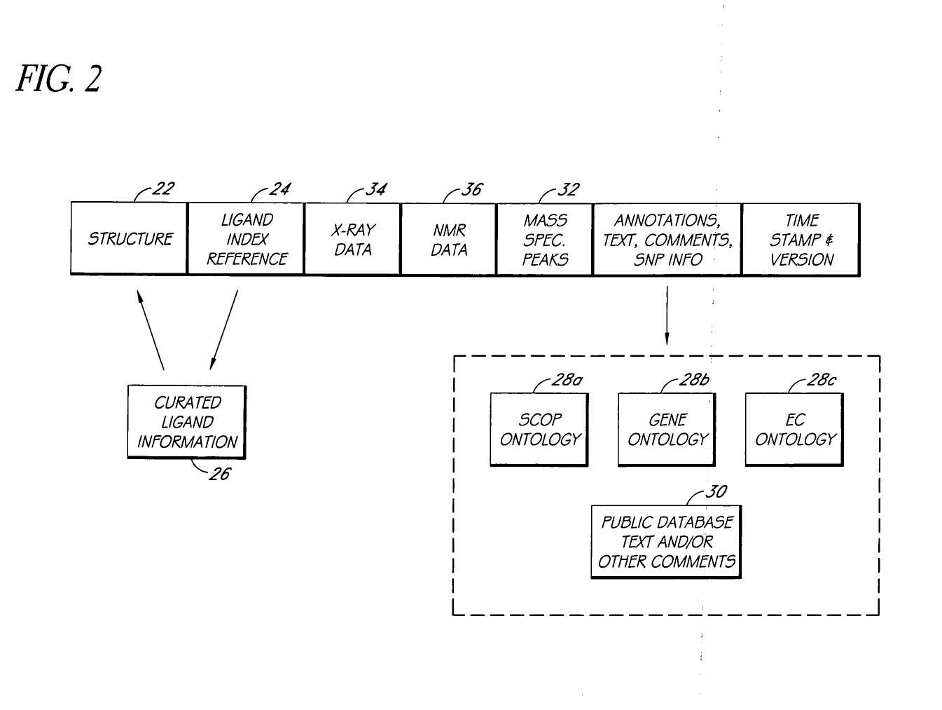

The records of the database are advantageously created from a variety of sources. For example, because a large amount of useful protein information is provided in publicly available databases 14 such as the PDB, it is advantageous to download protein structures, annotations, and any other available and desired information from one or more of these databases such that part or effectively all of the publicly available protein information in such databases is replicated on the internal database 10. In one embodiment of the invention, for example, the PDB is downloaded inclusive of all x-ray and/or NMR data initially and is updated periodically from the public data sources. A software parsing system parses the PDB header into a separate easily text searchable file format such as an XML file (see item 30 in FIG. 2) and processes the structural data to enrich the information via in silico approaches and through association with available genomic and structure-function characterizations. This allows the creation of powerful text search approaches unavailable currently, combining the best of Xpath XML file searching with SQL across-file searches. Importantly ligand information as contained within HET group data records, if present, is processed separately and additionally to check for the appropriate bond orders using the PDB provided HET Group Dictionary. Available ligand information may be enriched through in silico approaches and structural classification (e.g., functional groups, reactivity, etc.) and is stored using an Oracle Accord Data Cartridge to support rapid structural, substructural, and similarity searching based upon ligand attributes. Protein structures with bound ligand(s) are also enriched computationally with information that characterizes the nature of the interactions between the protein binding site and the ligand.

Proprietary structural data on a protein target and/or a protein-ligand complex can also be loaded into the database 10. Sources of the proprietary structures include experimental results, analysis, and software tools 16 for measuring physical protein structures or for modeling protein structures. Such results are performed by or for the entity, and are not present in the publicly available information duplicated on the database 10 from the publicly accessible database 14.

Registration of the data supports the application of user/site-defined business rules to address standardization and/or regularization of the data during the loading process. Individual structures are processed via a registration wizard and bulk registration is supported through a batch loading mechanism. The batch mechanism facilitates database creation and supports regular updating processes through an established workflow.

In some embodiments, sets of database records can correspond to protein structures generated from an entire genome of an organism. These sets may be available from public and/or proprietary sources 18 with rich structural annotations. Accelrys Software in San Diego Calif. has derived such sets for a variety of organisms using in silico techniques created by their commercially available DS GeneAtlas pipeline. These sets can be loaded using the process described above with respect to the PDB database. Structure-function and genomic associations contained within the existing database and the annotated genome(s) may advantageously be reconciled to produce a consistent view of the composite information. Although the PDB does include some theoretically computed annotated structures, no facility is provided for loading entire genomes of such structures.

FIG. 2 is a block diagram illustrating some of the information which may be stored in the database 10. As shown in this Figure, the record includes protein structure data 22 (all or a portion of interest of a protein), which may be experimentally or computationally derived, and which may or may not include a bound ligand. In one embodiment, only one copy of an attribute is stored (as a database index) that is likely to be shared by multiple proteins or by ligands that are bound to multiple protein structures. For example, while many protein structures in PDB have a particular ligand bound to the protein, only one copy of that ligand is curated for the purpose of structural searches which is linked back to the coordinates of the ligand conformation in the respective protein-ligand complex. Thus, a ligand reference 24 is associated with structure data in the database when the structure includes a ligand, and which refers to a set of curated ligand data 26, which may be referred to by other structure entries as well. This use of indexing that spans both protein and bound ligands offers a major advantage in integrating protein and ligand structures since it is neither protein nor ligand centric. A chemist can access information on a protein family related to a protein that binds a ligand of interest just as easily as a biologist can access the range of compounds that are known to bind to a protein family that is a distant homolog with a protein of interest. Along with being a more efficient storage approach this centralization of information facilitates robust error correction, This supports the expansion of the databases to store large numbers of in silico structural results, from thousands of known protein structures today to the millions of in silico models or protein structures with in silico docked ligands that are readily accessible with existing computation approaches. In some embodiments, ligand information available from corporate chemical structure data systems and proprietary genomic information can be automatically linked with each newly created data record.

The invention supports the general enrichment and extension of the loaded data through computational methods and the linking of classification and ancillary data that is widely available. In one embodiment, three protein-based ontologies are provided: a structural ontology in SCOP, a functional ontology in Enzyme Classification (E.C.), and a genomic oriented ontology in Gene Ontology (GO). In the case of proprietary data users can assign their proprietary structures to any or all of these ontological classifications during the registration process.

The Structural Classification of Proteins may be mapped to public PDB structures directly from the SCOP website. A flexible web-style browser allows users to select proteins both at various SCOP nodes, as well as at starting points to those nodes. Additionally, if users are uncertain what structural classification a given protein is given, they can reverse search for the classification assigned to a similar structure. This can be useful during registrtation of proprietary structures since a user can assign a SCOP classification based on a similar public structure.

Gene Ontology may be mapped indirectly from SwissProt ID to PDB ID, and E.C. may be mapped directly from the public Protein Data Bank, where E.C. numbers are parsed out of the PDB header fields. An automated parsing routine is included to search for E.C. references in several different header fields; it is common to find an E.C. number located either in a different PDB field, or within free text in the remarks section of the PDB file.

In one embodiment, a hybrid relational/XML data schema provides a simpler ontological mapping that facilitates the straightforward updating of ontologies while combining the strengths inherent within both XML and relational data models. While relational data storage has great advantages for indexing, data integrity, and rapid searching, its shortcomings are particularly apparent in the hierarchical data structures common to the definition of an ontology. It has thus been found advantageous to keep the mappings of the ontology node to the protein structure in relational table format while storing the hierarchical relationships between ontology nodes in a single large XML document 28a, 28b, 28c for each ontology.

The representative three ontologies cited above may each run as their own web server or web service. Other ontological tools can be similarly integrated as can any other tools that can logically or algorithmically make associations with a protein and/or ligand structure information stored within the database.

Another general enrichment of public and proprietary structural data involves the association of known single nucleotide polymorphisms (SNPs) in terms of their existence (a synonymous SNP) and their impact of amino acid mutation (a non-synonymous SNP). Facilities for querying and visualization of this information is discussed hereafter. A typical source of such SNP data is can be downloaded from the SNP Consortium download site at http://snp.cshl.org/downloads/.

Modern drug discovery efforts today often require data shared across geographically remote sites, and presents unique challenges in data concurrency and overall data synchronization. One advantageous system is multi-tier with a powerful query interface that represents a user-defined search as an XML document expressed separately from the underlying database server(s). Searches of the database are made possible by conversion of the XML to SQL. It can be advantageous to include a middle-tier based on SOAP, locating the XML to SQL conversion capability in a middle tier, and having the client and database server(s) conform to SOAP and Web Services protocols.

Several novel query methods are described below.

Searching for Ligands which have not been Automatically Curated

The public PDB includes an associated ligand dictionary known as the HET Group Dictionary. This dictionary is used to define ligands associated with database structures (e.g. chemical name, bond orders, etc.) which in turn permits the automatics typing of ligand records for subsequent structure, substructure, and similarity searches. In one embodiment of the database ligands contained within loaded protein structures are automatically typed if present in the HET Group Dictionary and so marked in the database. Proprietary structures being registered containing bound ligands are automatically typed by pulling ligand typing information from the corporate repository and so marked.

In one advantageous embodiment all structures not automatically typed can be identified for subsequent curation. Automatic curation can be performed manually or via a prescribed workflow employing suitable typing and clean-up components.

Searching for Binding Pocket Geometries and/or Similarities

In some embodiments, binding site geometry can also be searched in terms of overall volume, shape, and/or electronic composition. Searches can be exact in terms of numeric ranges or in terms of similarity metrics supported by the underlying methods used to summarize the shape and/or electronic composition of a binding site.

In one embodiment binding sites having a particular size range, shape and orientation can also be searched by expressing the binding site as an enclosing ellipsoid [8, 9] having a major axis approximately parallel to the surface of the protein structure.

Searching for Ligand-Protein Interactions

In some embodiments, ligand-protein interactions can also be searched in terms of the nature of interactions and the number of said interactions. Interactions types are stored as a fixed vocabulary that is defined by an installation of the database and can be defined for each ligand-protein complex manually or algorithmically using established or novel methods.

In one embodiment spatial relationships between identified interactions can also be captured and used in the context of a search.

Searching with Mass Spectroscopy Experimental Data

It has been found advantageous to include mass spectroscopy data 32 the ability to search the database with a query comprising experimentally derived mass spectroscopy peak lists to better integrate structural proteomic research with expressed protein research.

Searching with X-Ray Crystallography Experimental Data

It has been found advantageous to include x-ray crystallography data 34 and the ability to search the database with a query comprising experimentally determined crystallographic metrics of resolution, space group, etc. to better integrate structural biological research with expressed protein research.

Searching with NMR Spectroscopy Experimental Data

It has been found advantageous to include NMR data 36 the ability to search the database with a query comprising experimentally determined NMR summary information to better integrate structural biological research with expressed protein research.

Ligand Classification Using Ontologies

The available protein ontologies provide a means to classify bound ligands within the context of drug discovery that in many ways complements the chemical classifications typically employed within chemistry. The combination of protein and ligand data contained within some embodiments of the database allow users to perform novel workflows that can form relationships between chemical systems (i.e., ligands) that could not easily be made in other ways. As an example a researcher could start with mass spectral data search for a protein with a bound ligand and the then ligand used to find a similar ligand bound to another protein with known function through available ontological information.

There is an immediate application for an exciting workflow using this protein/ligand database that brings together three groups that together work on structure-based drug design: structural biologists, molecular modelers, and medicinal chemists.

It is common in modern structure-based design projects to produce hundreds of structures where the same protein is studied, but with different ligands bound. Other things besides the ligand may also vary, including the x-ray space group, the number of molecules in a symmetric unit, the solvent used, the details of the side chains, etc. A curator or group of users will assign these structures into a given project in DS AtlasStore, with a timestamp and any descriptive metadata about the experimental conditions. The user depositing each structure will become the owner of that structure, allowing them special privileges to modify data belonging to that structure. During deposition, a user will assign various protein ontologies to the structure (e.g. SCOP, GO, or E.C.), keywords, and textual annotation.

The user who sets up the project may define one structure as the reference structure. As other protein structures are determined and stored, their 3D coordinates can be transformed into the same frame of reference as the reference structure. This could be done based on the residues around the binding pocket, on the ligand of interest, or on a protein-wide RMSD minimization calculation. This will allow a view to be automatically computed for a new structure in comparison with existing ones, centered on the ligand of interest, and with active site residues highlighted. Simple operations will be available to overlay other structures in this project, highlighting which residue-ligand interactions were conserved in other structures and which are novel to this new structure. As a new structure is deposited, an email notification can be sent to medicinal chemists assigned to this project, so that they can view this graphical information.

This provides a basic workflow for communicating new structural information from structural biologists and crystallographers to medicinal chemists. Many kinds of workflow enhancements can be built on top of this system. This might include being able to search for ligand properties that have been federated to other ligand-oriented databases. For high-throughput screening databases, it would include the ability to search for target activity properties from assays involving a given ligand and target, as well as cellular activity or inhibition. It could also include searching for ADME or other physico-chemical properties.

In contrast to the workflow above, where a group of users is working with many different structures involving the same protein complexed to many different ligands, this workflow deals with the situation where a researcher is interested in a single protein structure. The researcher has found an interesting interaction (e.g. a particular charged group on the ligand appears to be interacting with an aromatic ring on a given protein residue). The researcher then searches DS AtlasStore for other protein/ligand interactions that have similar properties. She may also utilize information from high-throughput screening—particularly target activity—in looking at these other structures to see if this interaction is important for binding affinity. She might then slightly change the ligand property and redo the search, or slightly change the protein property and see how it affects the search results.

As described above, the database thus may include initial and weekly loading of the Protein Data Bank, with automated chemistry cleaning of the ligands and deposition of the x-ray data. The .pdb header format may be converted into an XML format for rapid text querying. Users can also deposit proprietary protein structures, as well as 3D annotated protein sequences and/or entire annotated genomes from GeneAtlas, a high-throughput structural annotation pipeline. Gene Ontology, Structural Classification of Proteins, and Enzyme Classification ontologies may also be regularly loaded and mapped. Query capabilities may include 2D ligand searches, protein 3D motifs, active sites and binding pocket searches, and BLAST sequence searches. Users can combine these searches with mass spectroscopy database searching and rich textual searching. In some embodiments, electron density maps can be calculated from loaded experimental data on the fly and displayed.

1. A system for storing protein structure information, said system comprising a non-public database storing protein structure information, wherein said non-public database is coupled to a public database of non-proprietary protein structure information and to non-public sources of proprietary protein structure information.

2. The system of claim 1, wherein said non-public database is also coupled to a database having protein structure information for substantially all the proteins of at least one organism genome.

3. The system of claim 1, wherein said non-public database stores ligand information.

4. The system of claim 3, wherein said non-public database stores a single copy of ligand information corresponding to a ligand that is part of the structural data associated with several different proteins having structure information stored in said non-public database.

5. A method of creating database records related to protein structure, said method comprising:
loading protein structure data from at least one public database;
loading protein structure data from one or more proprietary sources of protein structure information.

6. The method of claim 5, wherein said public database comprises the Protein Data Bank (PDB).

7. The method of claim 6, wherein said loading from the PDB comprises converting a PDB header into XML format.

8. The method of claim 5, additionally comprising loading protein structure data for substantially every protein of an organism genome from a database different from said public database.

9. The method of claim 5, additionally comprising loading classification data corresponding to at least one protein ontology.

10. The method of claim 9, comprising mapping protein structures to SCOP, Gene Ontology, and E.C.

11. The method of claim 9, wherein protein mappings to ontology nodes are stored in relational table format, and wherein relationships between ontology nodes are stored in a different format.

12. The method of claim 11, wherein said different format comprises an XML format.

13. The method of claim 5, additionally comprising loading mass spectroscopy data into said database.

14. The method of claim 5, additionally comprising loading NMR data into said database.

15. The method of claim 5, additionally comprising loading x-ray crystallography data into said database.

16. The method of claim 5, wherein loading proprietary structure information comprises formal registration comprising automatic enrichment of the raw structural information using in silico techniques and/or the linking of available structure-function information and/or the application of standard business rules during the loading process.

17. The method of claim 5, additionally comprising time stamping the date and/or time of loading a structure.
